(19) United States
(12) Patent Application Publication
(10) Pub. No.: US 2011/0139390 A1
(43) Pub. Date: Jun. 16, 2011

(54) PAPERMAKING BELT

(76) Inventors: Dean Van Phan, West Chester, OH (US); Paul Dennis Trokhan, Hamilton, OH (US)

(21) Appl. No.: 12/965,345

(22) Filed: Dec. 10, 2010

Related U.S. Application Data
(60) Provisional application No. 61/285,796, filed on Dec. 11, 2009.

(51) Int. Cl. D21F 11/00; D21G 9/00; B05D 5/00

(52) U.S. Cl. 162/202; 162/289; 427/243

(57) ABSTRACT

Papermaking belts and more particularly to papermaking belts that employ a porous member and a polymer associated with the porous member, processes for making such papermaking belts and processes for making a paper web utilizing such papermaking belts are provided.

### CROSS REFERENCE TO RELATED APPLICATION

This application claims the benefit of U.S. Provisional Application No. 61/285,796, filed Dec. 11, 2009.

### FIELD OF THE INVENTION

The present invention relates to papermaking belts and more particularly to papermaking belts that comprise a porous member and a polymer associated with the porous member, processes for making such papermaking belts and processes for making a paper web utilizing such papermaking belts.

### BACKGROUND OF THE INVENTION

Papermaking belts comprising a porous member, such as a woven fabric, and a polymer are known in the art. Such papermaking belts have been used to make fibrous structures, in particular paper webs that comprise a patterned imparted to them by the papermaking belt.

It is known that such prior art papermaking belts do not perform well in conventional wet pressed papermaking processes due typically to the total thickness of the papermaking belts, which does not permit the paper web formed thereon to dry effectively at the speeds associated with a typical conventional wet pressed papermaking process.

Accordingly, there is a need for a papermaking belt that comprises a porous member a polymer associated with the porous member that is capable of being used at a speed comparable to the typical conventional wet press papermaking process.

### SUMMARY OF THE INVENTION

The present invention fulfills the need described above by providing a papermaking belt comprising a porous member and a polymer associated with the porous member.

In one example of the present invention, a papermaking belt comprising a porous member and a polymer associated with at least a surface of the porous member such that the polymer layer covers less than the entire surface area of the surface of the porous member, wherein at least a portion of one of the porous member and/or polymer layer exhibits a contact angle, for example a water contact angle, of at least 100° as measured according to the Contact Angle Test Methods described herein, is provided.

In another example of the present invention, a process for making a papermaking belt according to the present invention, wherein the process comprises the steps of:

a. providing a porous member; and

b. associating a polymer with the porous member such that a papermaking belt is made; wherein at least a portion of one of the porous member and/or polymer layer exhibits a contact angle, for example a water contact angle, of at least 100° as measured according to the Contact Angie Test Methods described herein, is provided.

In yet another example of the present invention, a process for making a paper web, the process comprising the steps of:

a. depositing a fibrous slurry onto a forming wire to form an embryonic web; and

b. transferring the embryonic web to a papermaking belt comprising a porous member and a polymer associated with the porous member, wherein at least a portion of one of the porous member and/or polymer layer exhibits a contact angle, for example a water contact angle, of at least 100° as measured according to the Contact Angle Test Methods described herein, such that a paper web is formed, is provided.

Accordingly, the present invention provides a papermaking belt, a process for making a papermaking belt, and a process for making a paper web that is novel and provides benefits that have not been achievable before now.

### BRIEF DESCRIPTION OF THE DRAWINGS

FIG. 1 is a top plan view of a portion of an example of a papermaking belt according to the present invention; and

FIG. 2 is a cross-sectional view of the papermaking belt of FIG. 1 taken along line 2-2.

### DETAILED DESCRIPTION OF THE INVENTION

### Papermaking Belt

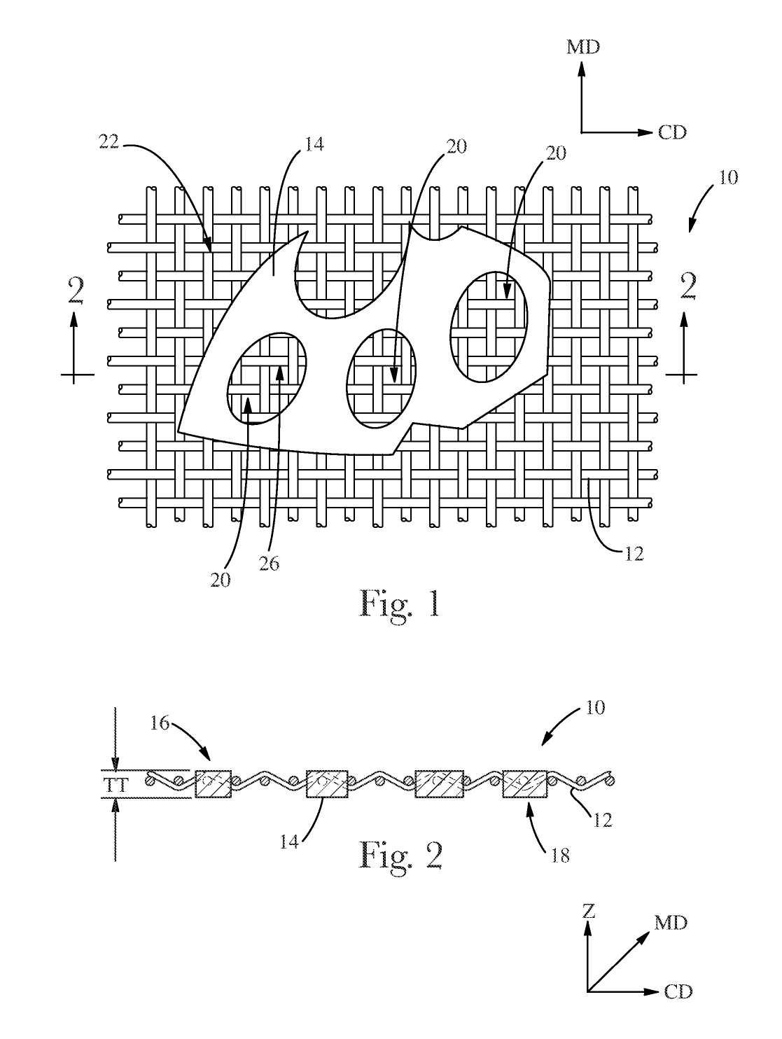

As shown in FIGS. 1 and 2, the papermaking belt 10 comprises a porous member 12 and a polymer 14 associated with the porous member 12. The papermaking belt 10 may be an endless belt.

The papermaking belt 10 has two opposed major surfaces. One major face is the paper web contacting side 16. The other major surface of the papermaking belt 10 is the backside 18, which contacts machinery employed in a typical papermaking operation. Machinery employed in a typical papermaking operation includes vacuum pickup shoes, rollers, etc., as are well known in the art and will not be further discussed herein.

Generally, for a papermaking belt 10 according to the present invention, the “machine direction” of the papermaking belt 10 is the direction within the plane of the papermaking belt 10 parallel to the principal direction of travel of a paper web during manufacture. The machine direction is designated by arrows “MD” in FIG. 1. The “cross-machine direction” (“CD”) is generally orthogonal to the machine direction and also lies within the plane of the papermaking belt 10. The Z-direction is orthogonal to both the machine direction and cross machine direction and generally normal to the plane of the papermaking belt 10 at any position in the papermaking process. The machine direction, cross machine direction, and Z-direction form a Cartesian coordinate system.

The papermaking belt 10 of the present invention is essentially macro-scopically monoplanar. As used herein an object is “macroscopically monoplanar” if such object has two very large dimensions in comparison to a relatively small third dimension. The papermaking belt 10 is essentially macroscopically monoplanar in recognition that deviations from absolute planarity are tolerable, but not preferred, so long as the deviations do not adversely affect the performance of the papermaking belt 10 in making a paper web thereon.

In one example, the papermaking belt 10 may comprise interstices 20 that are defined by the porous member 12 and the polymer 14 associated with the porous member 12 such that the interstices 20 allow fluids, such as water, to pass through the papermaking belt 10.

In one example, the polymer 14 is associated with a surface 22 of the porous member 12 in the form of a pattern. The pattern may be a non-random repeating pattern. The pattern may comprise a pattern of polymer knuckles 24. The pattern may comprise a pattern of continuous, discontinuous, semi-continuous and/or combinations thereof of polymer knuckles 24. The polymer knuckles 24 may form deflection conduits 26. The deflection conduits 26 receive fluids, such as water during a dewatering operation of a paper web being formed on the papermaking belt 10. The water received in the deflection conduits 26 further passes through the porous member 12 through the interstices 20 formed in the papermaking belt 10 and the porous member 12 during the dewatering operation.

In one example, at least a portion of the porous member and/or polymer, such as the polymer layer associated with at least a surface of the porous member, exhibits a contact angle, for example a water contact angle, of at least 100° and/or at least 105° and/or at least 110° and/or at least 115° and/or at least 120° as measured according to the Contact Angle Test Methods described herein. A prior art papermaking belt comprises a woven fabric and a polymer associated with the woven fabric, wherein at least a portion of the woven fabric and/or polymer exhibits a contact angle, for example a water contact angle, of 95° or less. Such a prior art belt is not suitable for the present invention.

If neither the porous member nor the polymer associated therewith has a portion that exhibits a contact angle, for example a water contact angle, of at least 100° and/or at least 105° and/or at least 110° and/or at least 115° and/or at least 120°, then a hydrophobic additive may be added to the porous member and/or polymer. In one example, a hydrophobic additive selected from the group consisting of fluoropolymers, silicone-based materials and mixtures thereof, may be applied as a coating to at least portions of the porous member and/or polymer. In another example, such a hydrophobic additive may be blended with the polymer. When blended with the polymer, at least a portion of the hydrophobic additive should bloom to the surface of the polymer, such as the polymer layer. By making the papermaking belt or portions thereof more hydrophobic than is known in the art, the papermaking belt carries less water with it and/or repels more water during the papermaking process utilizing the papermaking belt.

In one example, the papermaking belt of the present invention exhibits a total thickness (“TT” in FIG. 2) of no more than 0.40 mm and/or no more than 0.35 mm and/or 0.30 mm and/or no more than 0.28 mm and/or to about 0.05 mm and/or to about 0.10 mm as measured according to the Caliper Test Method described herein.

In another example, the papermaking belt and/or porous member of the present invention exhibits a fiber support index (“FSI”) of at least 165 and/or at least 168 and/or at least 175 and/or at least 180 and/or at least 190 and/or at least 195 as measured according to the Fiber Support Index Test described herein. In one example, the papermaking belt and/or porous member of the present invention exhibits a fiber support index (“FSI”) in at least one area of the papermaking belt that is void of the polymer, in one example in a deflection conduit, of at least 165 and/or at least 168 and/or at least 175 and/or at least 180 and/or at least 190 and/or at least 195 as measured according to the Fiber Support Index Test described herein.

In yet another example, the papermaking belt of the present invention exhibits a CD rigidity of less than 7 gf*cm²/cm and/or less than 6 gf*cm²/cm and/or less than 5 gf*cm²/cm and/or less than 4.5 gf*cm²/cm and/or to about 0.5 gf*cm²/cm and/or to about 1 gf*cm²/cm as measured according to the CD Rigidity Test Method described herein.

Table 1 below shows the two papermaking belts in accordance with the present invention and six papermaking belts (A-F) that fall outside the claimed invention.

TABLE 1

| | | | Thickness | | | TT | | |
|---|---|---|---|---|---|---|---|---|
| | | Air | of Porous | Filament | Overburden | of | | |
| | Porous | Perm | Member | Diameter | of Polymer | Belt | | CD Rigidity |
| Belt | Member | (cfm) | (mm) | (mm) | (mm) | (mm) | FSI | (gf * cm²/cm) |
| Invention | Monolayer | 588 | 0.27 | 0.15 × 0.11 | 0.05 | 0.32 | 196 | <4.4 |
| | Woven | | | | | | | |
| | Fabric | | | | | | | |
| Invention | Monolayer | 478 | 0.29 | 0.15 × 0.15 | 0.05 | 0.33 | 168 | <4.4 |
| | Woven | | | | | | | |
| | Fabric | | | | | | | |
| A | Dual | 1094 | 0.64 | 0.18 × 0.20 | 0.05 | 0.69 | 101 | 6.96 |
| | Layer | | | | | | | |
| | Woven | | | | | | | |
| | Fabric | | | | | | | |
| B | Dual | 378 | 0.51 | 0.18 × 0.20 | 0.05 | 0.56 | 100 | — |
| | Layer | | | | | | | |
| | Woven | | | | | | | |
| | Fabric | | | | | | | |
| C | Monolayer | 1117 | 0.33 | 0.18 × 0.18 | 0.05 | 0.38 | 102 | 4.46 |
| | Woven | | | | | | | |
| | Fabric | | | | | | | |
| D | Monolayer | 466 | 0.31 | 0.18 × 0.18 | 0.05 | 0.36 | 120 | — |
| | Woven | | | | | | | |
| | Fabric | | | | | | | |
| E | Monolayer | 368 | 0.28 | 0.18 × 0.18 | 0.05 | 0.33 | 145 | — |
| | Woven | | | | | | | |
| | Fabric | | | | | | | |
| F | Monolayer | 526 | 0.28 | 0.15 × 0.15 | 0.05 | 0.33 | 161 | <4.4 |
| | Woven | | | | | | | |
| | Fabric | | | | | | | |

The papermaking belt 10 is suitable for making a paper web, such as a fibrous structure, which can be incorporated into a sanitary tissue product.

### Porous Member

As used herein, a “porous member” is a member that has plurality of pores or interstices through which a fluid, such as water and/or air, is able to pass.

As shown in FIGS. 1 and 2, the porous member 12 of the present invention may comprise a fibrous structure. The fibrous structure in one example may comprise one or more fibrous elements such as filaments and/or fibers. In one example, one or more of the filaments may exhibit a diameter of less than 0.15 mm and/or less than 0.12 mm and/or less than 0.10 mm and/or less than 0.08 mm and/or less than 0.05 mm and/or to about 0.005 mm and/or to about 0.01 mm and/or to about 0.02 mm. The filaments may comprise and/or be formed from a polymer selected from the group consisting of: polyester, polyamide, polyphenylene sulfide, polyethylene, polypropylene, polytetrafluoroethylene such as Teflon® commercially available from DuPont, poly praraphenylene terephthalamide such as Kevlar® commercially available from DuPont and mixtures thereof. In one example, the porous member may comprise carbon fibers.

The fibrous structure may be a woven fabric and/or a nonwoven.

The woven fabric may comprise warp and weft filaments where warp filaments are parallel to the machine direction and weft filaments are parallel to the cross-machine direction. The filaments of the woven fabric may be so woven and complementarily serpentinely configured at least in the Z-direction of the lamina to provide a first grouping or array of coplanar surface-plane crossovers of both warp and weft filaments an a predetermined second grouping or array of sub-surface crossovers of both warp and weft. The arrays can be interspersed so that portion of the surface-plane crossovers define an array of wicker-basket-like cavities in the surface of the woven fabric. The cavities may be disposed in a staggered relation in both the machine direction and the cross-machine direction such that each cavity spans at least one sub-surface crossover.

For a woven fabric, the term “shed” is used to define the number of warp filaments involved in a minimum repeating unit. The term “square weave” is defined as a weave of n-shed wherein each filament of one set of filaments (e.g., wefts or warps), alternately crosses over one and under n−1 filaments of the other set of filaments (e.g., wefts or warps) and each filament of the other set of filaments alternately passes under one and over n−1 filaments of the first set of filaments.

The woven fabric of the present invention is required to form and support a paper web and allow water to pass through. The woven fabric can comprise a “semi-twill” having a shed of 3 where each warp filament passes over two weft filaments and under one weft filament in succession and each weft filament passes over one warp filament and under two warp filaments in succession. In another example, the woven fabric may comprise a “square weave” having a shed of 2 where each warp filament passes over one weft filament and under one weft filament and each weft filament passes over one warp filament and under one warp filament in succession.

In addition to woven fabric, the porous member may be cast from a polymer, such as in the form of a porous film and/or foam.

The porous member 12 is such that it does not present significant obstruction to the flow of fluids, such as water therethrough and, therefore, should be permeable (and may be highly permeable). The permeability of the porous member 12 may be measured by the airflow therethrough at a differential pressure of about 1.3 centimeters of water. In one example, a porous member 12 having no polymer 14 associated with it has a permeability at a differential pressure of about 1.3 centimeters of water of about 240 to about 490 standard cubic meters per minute per square meter of papermaking belt 10 area. Of course, it will be apparent that the permeability of the papermaking belt 10 will be reduced when the polymer 14 is associated with the porous member. In one example, a papermaking belt 10 of the present invention exhibits an air permeability of about 90 to 180 and/or of from about 90 to about 150 and/or of from about 100 to about 130 standard cubic meters per minute per square meter.

In one example, the porous member may comprise a woven fabric that comprises vertically stacked machine direction filaments to provide increased stability and load bearing capability. By vertically stacking the machine direction filaments of the woven fabric, the overall durability and performance of the papermaking belt according to the present invention is enhanced.

The porous member may be a monolayer porous member or a multi-layer porous member, such as a dual layer woven fabric.

The thickness of the porous member 12 may vary so long as the total thickness of the papermaking belt is no more than 0.40 mm. In one example, the thickness of the porous member 12 is no more than 0.35 mm and/or 0.30 mm and/or no more than 0.28 mm and/or to about 0.05 mm and/or to about 0.10 mm. The porous member 12 may exhibit the desired thickness at the time of purchase or it may be modified to a specific thickness by sanding the porous member 12, such as a woven fabric, to achieve the desired thickness.

Non-limiting examples of suitable porous members include woven fabrics commercially available from Albany International. Corporation of Albany, N.Y.

### Polymer

The polymer 14 associated with the porous member 12 of the papermaking belt 10 of the present invention may comprise any suitable polymer capable of withstanding the dewatering operation of the papermaking process. Non-limiting examples of suitable polymers including thermoplastic, thermoset, photopolymer and mixtures thereof. In one example, the polymer comprises a urethane methacrylate photopolymer. In another example, the polymer comprises a polyurethane polymer.

The polymer 14 may be associated with the porous member 12 in any suitable manner. In one example, the polymer 14 may become associated with the porous member 12 by applying the polymer 14 to surround and envelop the porous member 12. In one example, the polymer 14 is a photopolymer where once the photopolymer is applied, portions of the photopolymer that are desired to remain associated with the porous member 14, such as in the form of a pattern, are cured, and those portions not desired to remain associated with the porous member 14 are washed away in its uncured state. A mask can be used to ensure that only those portion of the photopolymer that need to be cured are cured and those that do not need cured remain in their uncured state.

In one example, the polymer 14 extends outward from the porous member 12 by no more than 0.15 mm and/or no more than 0.10 mm and/or no more than 0.05 mm and/or no more than 0.02 mm. In one example, the polymer 14 can be approximately coincident the surface-plane of the porous member 12.

The polymer 14 may be continuous or discontinuous. It may cover greater than 2% and/or greater than 10% and/or greater than 30% and/or greater than 50% and/or greater than 75% and/or less than 100% and/or less than 99% and/or less than 95% and/or less than 90% of the surface area of at least a surface of the porous member 12, such as the surface of the porous member 12 that forms the paper web contacting side 16 of the papermaking belt 10. The polymer 14 may be present in shapes, geometric figures, text and/or graphic depictions. In one example, the polymer 14 defines a continuous knuckle 24 that forms polymer void areas resulting in deflection conduits 26 within the papermaking belt 10.

### Process of Making the Papermaking Belt

The papermaking belt according to the present invention may be made by any suitable process known in the art.

In one example, the papermaking belt is made by a process comprising the steps of:

c. providing a porous member; and

d. associating a polymer with the porous member such that a papermaking belt is made; wherein at least a portion of one of the porous member and/or polymer exhibits a contact angle, for example a water contact angle, of at least 100°.

In another example, the papermaking belt of the present invention may be formed by a process comprising the steps of:

a. providing a porous member, such as a woven fabric;

b. applying a liquid photopolymer, such as a liquid photosensitive resin, to a surface of the porous member;

c. curing at least portions of the liquid photopolymer present on the porous member; and

d. removing any uncured liquid photopolymer from the porous member to form the papermaking belt.

### Process for Making a Paper Web

The papermaking belt of the present invention may be used in any suitable papermaking process to make a paper web.

In one example, a process for making a paper web according to the present invention comprises the steps of:

a. depositing a fibrous slurry, for example a fibrous slurry comprising pulp fibers, onto a forming wire to form an embryonic web; and

b. transferring the embryonic web to a papermaking belt comprising a porous member and a polymer associated with the porous member, wherein the papermaking belt exhibits a total thickness of no more than 0.40 mm, a fiber support index of at least 165 and a CD rigidity of less than 7 gf*cm²/cm such that a paper web is formed.

The paper web made by this process and in accordance with the present invention may be used to make a single- or multi-ply sanitary tissue product.

The papermaking belt according to the present invention may be used in a conventional wet press papermaking operation and/or in a through-air-dried papermaking operation. The papermaking belt may be used in conjunction with a pressure roll and/or with one or more felts to help dewater the paper web being formed on the papermaking belt. In another example, the papermaking belt may be used in a shoe press papermaking operation, with no felt, a single felt or sandwiched between two or more felts. In yet another example, the papermaking belt may be used to make structured paper web on a conventional wet press papermaking machine. In still another example, the papermaking belt of the present invention may be used in papermaking processes that run at speeds of greater than 4000 and/or greater than 5000 and/or greater than 6000 feet per minute.

### Non-limiting Example of Papermaking Belt

A papermaking belt of the present invention is made by casting a photopolymer in a pattern having a knuckle area of about 65% onto a polyester woven fabric (86×104 2S, which has a warp filament diameter of 0.15 mm and a shute filament diameter of 0.11 mm), which is heat treated to reduce its thickness to about 0.272 mm such that the total thickness of the papermaking belt of no more than 0.40 mm.

### Test Methods

Unless otherwise indicated, all tests described herein including those described in the following test methods are conducted on samples that have been conditioned in a conditioned room at a temperature of 73° F.±4° F. (about 23° C.±2.2° C.) and a relative humidity of 50%±10% for 2 hours prior to the test. Further, all tests are conducted in such conditioned room.

### Contact Angle Test Methods

### A. Sessile Drop

The water contact angle of a portion of the porous member and/or polymer associated with the porous member is measured according to the following method.

The contact angle of the porous member and/or polymer layer is measured using a First Ten Angstroms, Inc. (Portsmouth, Va. 23704) Model 200 Dynamic Contact Angle Analyzer water (HPLC grade, Aldrich). A Sessile drop contact angle analysis using 5-7 μL of water drop is deposited on the porous member and/or polymer layer at 20° C. A dangling drop was lowered at 1 mm/s until it gently touched the surface. Video imaging captured the drop contacting the surface. The Sessile contact angles are captured by video imaging at 0.0083 s/image for a total of 2 seconds from the time the drop detached from the needle. FTA software version 2.0, build 303 is used to determine the contact angles.

### B. Washburn

Contact angle can also be determined with a Kruss GmbH (Hamburg, Germany) KF100SF single fiber tensiometer. A 1 inch square segment of the belt was mounted so an edge was parallel with the surface of water (HPLC grade, Aldrich). The square is lowered at 6 mm/s until the surface was detected (0.01 g sensitivity). The square is then lowered at 0.05 mm/s with contact angles recorded at every 0.2 mm immersion until the square is lowered 5 mm. After 1 second, the square is retracted at the same rate of speed (0.05 mm/s) with data acquired at the same immersion depths (every 0.2 mm). Kruss GmbH Laboratory Desktop software version 3.1.1.2623 with Contact Angle and Surface and Interfacial Tension Add-Ins are used to determine contact angles.

### Caliper Test Method

The caliper or thickness, such as the total thickness, of a papermaking belt or porous member sample is determined using a Thwing-Albert ProGage Model 89-2012 Thickness Tester available from Thwing-Albert of West Berlin, N.J. The measurement is conducted using a load of 0.65 pounds applied through a 2 inch diameter foot. Report the thickness and/or total thickness of the papermaking belt and/or porous member sample in mm.

### Fiber Support Index Test Method

The fibrous support index (“FSI”) of a papermaking belt or porous member sample is calculated as follows.

FSI=2/3(aNₘ+2bN_{c})

wherein Nₘ is the number of machine direction filaments/inch; N_{c} is the number of cross-machine direction filaments/inch; a and b are coefficients for the contribution of support from machine direction filaments and cross-machine direction filaments. The coefficients are a function of the weave and running orientation of the filaments. For a plain, or square weave, a and b are both equal to 1.

### CD Rigidity Test Method

The CD Rigidity of the papermaking belt and/or porous member sample is measured using a Pure Bending Test to determine the bending stiffness using a KES-FB2 Pure Bending Tester available from Kato Tekko Co. Ltd., Kyoto, Japan.

Papermaking belt and/or porous member samples (2) are cut to approximately 1.6×7.5 cm in the cross-machine direction. The sample width is measured to a tolerance of 0.001 in. using a Starrett dial indicating vernier caliper. The sample width is converted to centimeters. The first (web facing) surface and the second (machine facing) surface of each sample are identified and marked. Each sample in turn is placed in the jaws of the KES-FB2 such that the sample would first be bent with the first surface undergoing tension and the second surface undergoing compression. In the orientation of the KES-FB2 the first surface is right facing and the second surface is left facing. The distance between the front moving jaw and the rear stationary jaw is 1 cm. The sample is secured in the instrument in the following manner. First the front moving chuck and the rear stationary chuck are opened to accept the sample. The sample is inserted midway between the top and bottom of the jaws. The rear stationary chuck is then closed by uniformly tightening the upper and lower thumb screws until the sample is snug, but not overly tight. The jaws on the front stationary chuck are then closed in a similar fashion. The sample is adjusted for squareness in the chuck, then the front jaws are tightened to insure the sample is held securely. The distance (d) between the front chuck and the rear chuck is 1 cm. The output of the instrument is load cell voltage (Vy) and curvature voltage (Vx). The load cell voltage is converted to a bending moment normalized for sample width (M) in the following manner: Moment (M, gf*cm/cm)=(Vy*Sy*d)/W where Vy is the load cell voltage, Sy is the instrument sensitivity in gf*cm/V, d is the distance between the chucks, and W is the sample width in centimeters. The sensitivity switch of the instrument is set at 5×1. Using this setting the instrument is calibrated using two 50 gram weights. Each weight is suspended from a thread. The thread is wrapped around the bar on the bottom end of the rear stationary chuck and hooked to a pin extending from the front and back of the center of the shaft. One weight thread is wrapped around the front and hooked to the back pin. The other weight thread is wrapped around the back of the shaft and hooked to the front pin. Two pulleys are secured to the instrument on the right and left side. The top of the pulleys are horizontal to the center pin. Both weights are then hung over the pulleys (one on the left and one on the right) at the same time. The fall scale voltage is set at 10V. The radius of the center shaft is 0.5 cm. Thus the resultant full scale sensitivity (Sy) for the Moment axis is 10 gf*0.5 cm/10V (5 gf*cm/V). The output for the Curvature axis is calibrated by starting the measurement motor and manually stopping the moving chuck when the indicator dial reaches 1.0 cm^{31 1}. The output voltage (Vx) is adjusted to 0.5 volts. The resultant sensitivity (Sx) for the curvature axis is 2/(volts*cm). The curvature (K) is obtained in the following manner:

Curvature(K,cm^{31 1})=Sx*Vx

where Sx is the sensitivity of the curvature axis and Vx is the output voltage.

For determination of the bending stiffness the moving chuck is cycled from a curvature of 0 cm⁻¹ to +1 cm⁻¹ to −1 cm⁻¹ to +0 cm⁻¹ at a rate of 0.5 cm ⁻1/sec. Each sample is cycled continuously until four complete cycles are obtained. The output voltage of the instrument is recorded in a digital format using a personal computer. At the start of the test there is no tension on the sample. As the test begins the load cell begins to experience a load as the sample is bent. The initial rotation is clockwise when viewed from the top down on the instrument. In the forward bend the first surface of the sample is described as being in tension and the second surface is being compressed. The load continues to increase until the bending curvature reaches approximately +1 cm⁻¹ (this is the Forward Bend (FB)). At approximately +1 cm⁻¹ the direction of rotation is reversed. During the return the load cell reading decreases. This is the Forward Bend Return (FBR). As the rotating chuck passes 0 curvature begins in the opposite direction that is the first surface now compresses and the second surface now extends. The load continues to increase until the bending curvature reaches approximately −1 cm⁻¹ (this is the Backward Bend (BB)). At approximately −1 cm⁻¹ the direction of rotation is reversed and the Backward Bend Return (BR) is obtained. The data is analyzed in the following manner. A linear regression line is obtained between approximately 0.2 and 0.7 cm⁻¹ for the Forward Bend and the Forward Bend Return. A linear regression line is obtained between approximately −0.2 and −0.7 cm⁻¹ for the Backward Bend and the Backward Bend Return. The slope of each line is the CD Rigidity or also known as the Bending Stiffness. It has units of gf*cm²/cm. The individual segment values for the four cycles are averaged and reported as an average FB, FBR, BBF, BBR. Two separate samples in the cross-machine direction are run. Values for the two samples are averaged together to arrive at the CD Rigidity of the papermaking belt and/or porous member sample,

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A papermaking belt comprising a porous member and a polymer layer associated with at least a surface of the porous member such that the polymer layer covers less than the entire surface area of the surface of the porous member, wherein at least a portion of one of the porous member and/or polymer layer exhibits a contact angle of at least 100°.

2. The papermaking belt according to claim 1 wherein the porous member comprises a fibrous structure.

3. The papermaking belt according to claim 2 wherein the fibrous structure comprises filaments.

4. The papermaking belt according to claim 3 wherein the filaments exhibit a diameter of less than 0.15 mm.

5. The papermaking belt according to claim 3 wherein the filaments comprise a polymer selected from the group consisting of: polyester, polyamide, polyphenylene sulfide, polyethylene, polypropylene, polytetrafluoroethylene, and mixtures thereof.

6. The papermaking belt according to claim 2 wherein the fibrous structure is a woven fabric.

7. The papermaking belt according to claim 2 wherein the fibrous structure is a nonwoven.

8. The papermaking belt according to claim 1 wherein the polymer layer comprises a thermoplastic polymer.

9. The papermaking belt according to claim 1 wherein the polymer layer comprises a thermoset polymer.

10. The papermaking belt according to claim 1 wherein at least a portion of one of the porous member and/or polymer layer exhibits a contact angle of at least 105°.

11. The papermaking belt according to claim 1 wherein at least a portion of one of the porous member and/or polymer layer exhibits a contact angle of at least 110°.

12. The papermaking belt according to claim 1 wherein the polymer layer comprises a photopolymer.

13. The papermaking belt according to claim 1 wherein the polymer layer is associated with at least the surface of the porous member in the form of a pattern.

14. The papermaking belt according to claim 11 wherein the pattern is a non-random repeating pattern.

15. The papermaking belt according to claim 11 wherein the pattern comprises a pattern of polymer knuckles.

16. The papermaking belt according to claim 11 wherein the pattern comprises a pattern of continuous, discontinuous, semi-continuous and combinations of the three.

17. The papermaking belt according to claim 1 wherein the papermaking belt exhibits a total thickness of no more than 0.40 mm, a fiber support index of at least 165 and a CD rigidity of less than 7 gf*cm²/cm.

18. A papermaking belt comprising a porous member, wherein at least a portion of the porous member exhibits a contact angle of at least 100°.

19. A process for making a papermaking belt comprising the steps of:
a. providing a porous member; and
b. associating a polymer with the porous member such that a papermaking belt is made;
wherein the papermaking belt exhibits a contact angle of at least 100°.

20. A process for making a paper web, the process comprising the steps of
a. depositing a fibrous slurry onto a forming wire to form an embryonic web; and
b. transferring the embryonic web to a papermaking belt comprising a porous member and a polymer associated with the porous member, wherein the papermaking belt exhibits a contact angle of at least 100° such that a paper web is formed.
